(19) United States
(12) Patent Application Publication
(10) Pub. No.: US 2018/0218752 A1
(43) Pub. Date: Aug. 2, 2018

(54) HEAT ASSISTED RECORDING MEDIA INCLUDING MUTLI-LAYER GRANULAR HEATSINK

(71) Applicant: Seagate Technology LLC, Cupertino, CA (US)

(72) Inventors: Bin LU, San Ramon, CA (US); Yingguo PENG, San Ramon, CA (US); Jan-Ulrich THIELE, Sunnyvale, CA (US)

(21) Appl. No.: 15/422,379

(22) Filed: Feb. 1, 2017

(51) Int. Cl. G11B 5/73; G11B 5/84; G11B 5/851; G11B 5/667

(52) U.S. Cl. CPC G11B 5/7325; G11B 5/667; G11B 5/851; G11B 5/8404

(57) ABSTRACT

Provided herein is a method including depositing an amorphous magnetic soft underlayer (SUL) over a substrate. A first portion of a heatsink layer is deposited over the SUL, wherein the first portion includes first heat conductive grains that are separated by first grain boundaries. A second portion of the heatsink layer is deposited over the first portion, wherein the second portion includes second heat conductive grains that are separated by second grain boundaries. The second grain boundaries are thicker than the first grain boundaries. A third portion of the heatsink layer is deposited over the second portion, wherein the third portion includes third heat conductive grains that are separated by third grain boundaries. The third grain boundaries are thicker than the second grain boundaries. A granular recording layer is deposited over the heatsink layer.

### BACKGROUND

Certain devices use disk drives with magnetic recording media to store information. For example, disk drives can be found in many desktop computers, laptop computers, and data centers. Magnetic recording media store information magnetically as bits. Bits store information by holding and maintaining a magnetization that is adjusted by a disk drive head. In order to store more information on a disk, bits are made smaller and packed closer together, thereby increasing the density of the bits. Therefore as the bit density increases, disk drives can store more information. However as bits become smaller and are packed closer together, the bits become increasingly susceptible to erasure, for example due to thermally activated magnetization reversal or adjacent track interference.

### SUMMARY

Provided herein is a method including depositing an amorphous magnetic soft underlayer over a substrate. A first portion of a heatsink layer is deposited over the SUL, wherein the first portion includes first heat conductive grains that are separated by first grain boundaries. A second portion of the heatsink layer is deposited over the first portion, wherein the second portion includes second heat conductive grains that are separated by second grain boundaries. The second grain boundaries are thicker than the first grain boundaries. A third portion of the heatsink layer is deposited over the second portion, wherein the third portion includes third heat conductive grains that are separated by third grain boundaries. The third grain boundaries are thicker than the second grain boundaries. A granular recording layer is deposited over the heatsink layer. These and other features and advantages will be apparent from a reading of the following detailed description.

### BRIEF DESCRIPTION OF DRAWINGS

FIG. 1 shows a heat assisted magnetic recording media at an intermediate stage of manufacture according to one aspect of the present embodiments.

FIG. 2 shows the heat assisted magnetic recording media including a heatsink layer according to one aspect of the present embodiments.

FIG. 3 shows the heat assisted magnetic recording media including a recording layer according to one aspect of the present embodiments.

FIGS. 4 shows the heat assisted magnetic recording media including a magnetic sealer layer and an overcoat layer according to one aspect of the present embodiments.

FIG. 5 shows an exemplary flow diagram for creating heat assisted magnetic recording media according to one aspect of the present embodiments.

FIG. 6 shows another exemplary flow diagram for creating heat assisted magnetic recording media according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “middle,” “bottom,” “beside,” “forward,” “reverse,” “overlying,” “underlying,” “up,” “down,” or other similar terms such as “upper,” “lower,” “above,” “below,” “under,” “between,” “over,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Terms such as “over,” “overlying,” “above,” “under,” etc. are understood to refer to elements that may be in direct contact or may have other elements in-between. For example, two layers may be in overlying contact, wherein one layer is over another layer and the two layers physically contact. In another example, two layers may be separated by one or more layers, wherein a first layer is over a second layer and one or more intermediate layers are between the first and second layers, such that the first and second layers do not physically contact.

As the technology of magnetic recording media reaches maturity, it becomes increasingly difficult to continue to increase the storage capacity of recording media (e.g. disk drive disks) or to reduce the size of recording media while maintaining storage capacity. Such challenges may be overcome by increasing the bit density on the recording media. However, increasing the bit density can decrease the signal to noise ratio (“SNR”) below acceptable levels. SNR can be increased by using ultra-thin magnetic films to bring the magnetic read/write head closer to the recording media. However, ultra-thin magnetic films lower the thermal stability of the grains within the bits, thereby increasing the grains' susceptibility to fluctuation and information loss. Embodiments described below address these concerns with heat assisted magnetic recording (“HAMR”).

With a HAMR drive, media with a magnetically strong recording layer is heated during a magnetic writing process. The heat temporarily lowers the magnetic strength of the recording layer, allowing a write head to magnetically record information. After the information is written, the media cools and the magnetic strength returns. In the cooled, magnetically strong state, the HAMR media is highly resistant to magnetic and thermal fluctuation, thereby locking in the recorded information.

In order to form the magnetically strong recording layer of HAMR media, the magnetic material is deposited at high temperature (e.g. 400-600° C.). The high temperature promotes chemical ordering of magnetic material, thereby forming an anisotropic structure with a high kᵤ (e.g. strongly magnetic). However, the high temperature causes recording grains to become larger, thereby decreasing recording density and storage capacity. In embodiments described herein, it has been unexpectedly discovered that by controlling the granularity of underlying heatsink layers, the desired small grain size of the overlying recording layers may be controlled during the high temperature deposition.

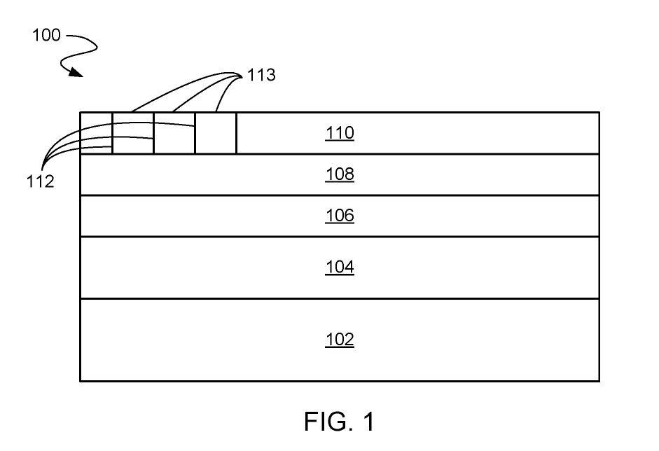

Referring now to FIG. 1, a HAMR media 100 at an intermediate stage of manufacture is shown according to one aspect of the present embodiments. A substrate 102 is provided. In various embodiments, the substrate 102 is disc shaped may include a non-magnetic metal, alloy, or non-metal. For example, the substrate 102 may comprise aluminum, an aluminum alloy, glass, ceramic, glass-ceramic, polymeric material, a laminate composite, or any other suitable non-magnetic material.

Overlying the substrate 102 is a continuous amorphous soft magnetic underlayer (“SUL”) 104. The SUL 104 may include one or more layers of a soft magnetic material. For example, the SUL 104 may be a 10 to 2000 Å thick layer including a soft magnetic material such as Ni, NiFe, Co, CoZr, CoZrCr, CoZrNb, CoCrTaB, CoCrB, CoCrTa, CoFe, Fe, FeN, FeSiAl, FeSiAlN, FeCoC, etc. In some embodiments, the SUL 104 may include multiple SUL layers, the multiple SUL layers may be either ferromagnetically coupled or antiferromagnetically coupled. In addition, the multiple SUL layers may be separated by one or more layers. Various embodiments may include an optional wetting layer 106 (e.g. Ta wetting layer).

Overlying the SUL 104 is a first orientation control layer 108. The first orientation control layer 108 may have a thickness from 5-200 Å. The first orientation control layer 108 sets the crystal orientation. In various embodiments the first orientation control layer 108 includes a (200) oriented thin film of transition metal or alloy of bcc structure. The first orientation control layer 108 may include a CrX alloy, wherein X may be, for example, Mo, W, V, Hf, Fe, Ni, Nb, Ta, Zr, Mn. In some embodiments, CrX may be deposited, for example, by sputtering or other techniques, at a temperature above room temperature (e.g. 100-300° C.). In some embodiments the first orientation control layer may include an alloy of bcc metal with its additives, such as, MoX, WX, VX, TaX, wherein X may be, for example, Cr, Mo, W, V, Hf, Fe, Ni, Nb, Ta, Zr, Mn.

Overlying the first orientation control layer 108 is a second orientation control layer 110. The second orientation control layer 110 may have a thickness from 5-200 Å. In various embodiments, the second orientation control layer 110 copies the (200) orientation of the first orientation control layer 108. In addition, the second orientation control layer 110 includes a segregant added to the CrX alloy of the first orientation control layer in order to define grain boundaries 112 and grains 113. The segregant may be, for example, C, B, BC, BN. Thus, for example, the first orientation control layer 108 may include CrMo, and the second orientation control layer 110 may include CrMoB. In other embodiments the second orientation control layer 110 may include CrB, and the X (e.g. Mo) may be omitted, it also may include MoB, MoC, and other bcc metal with segregants. For clarity of illustration, only a few of the grain boundaries 112 and grains 113 are illustrated, and it is understood that any number of grain boundaries 112 and grains 113 may be present.

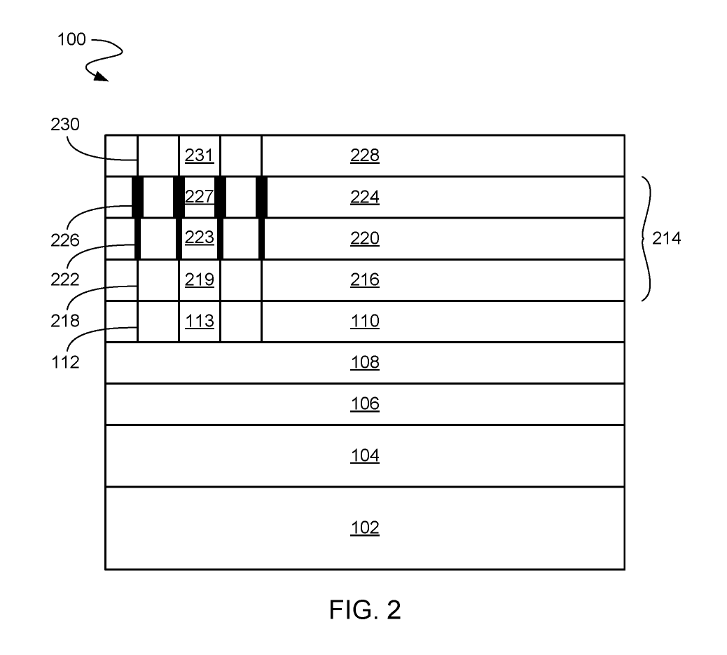

Referring now to FIG. 2, the HAMR media 100 including a heatsink layer 214 is shown according to one aspect of the present embodiments. The heatsink layer 214 overlies the second orientation control layer 110. In the present embodiment, the heatsink layer 214 includes three layers: a first portion 216, a second portion 220, and a third portion 224. However, it is understood that in various embodiments the heatsink layer 214 may include any number of layers.

In the present embodiment, the first portion 216 of the heatsink layer 214 overlies the second orientation control layer 110. The first portion 216 may have a thickness from 5-1000 Å. The first potion 216 includes a heat conductive material that is alloyed with a segregant. Grain boundaries 218 include the segregant and define heat conductive grains 219. As a result, the heatsink layer 214 is granular. For example, Mo (a heat conductive material) may be alloyed with other elements (segregants), such as, W, B, BN, BC, Ru, Cr, C, V, Nb, Hf, Zr, and Ti. In addition, other alloys such as W-alloys and Ru-alloys may be used, and may include, for example, B, BN, BC, Ru, W, Mo, Cr, C, V, Nb, Hf, Zr, and Ti as additives. In various embodiments, the first portion 216 maintains the (200) orientation. Heat may be applied before or after deposition of the first portion 216 in order to promote and ensure ample diffusion of the segregant into the grain boundaries 218. If Ru is used, the crystalline orientation of the film is (11.0) or (1120) in 4 indices system for a hexagonal close pack (hcp) structure.

A second portion 220 of the heatsink layer 214 overlies the first portion 216. The second portion 220 may have a thickness from 5-1000 Å. The second portion 220 is granular and includes more of the segregant than the first portion 216. As such, grain boundaries 222 in the second portion 220 are thicker than the grain boundaries 218 in the first portion 216. In various embodiments, the grain boundaries 222 in the second portion 220 include a greater volume of material than the grain boundaries 218 in the first portion 216. The grain boundaries 222 define heat conductive grains 223 in the second portion 220. In various embodiments, the second portion 220 maintains the (200) orientation (or (1120) orientation if hcp Ru is used). In some embodiments, the segregant in the second portion 220 may be the same material or a different material than the segregant in the first portion 216. Heat may be applied before or after deposition of the second portion 220 in order to promote and ensure ample diffusion of the segregant into the grain boundaries 222.

A third portion 224 of the heatsink layer 214 overlies the second portion 220. The third portion 224 may have a thickness from 5-1000 Å. The third portion 224 is granular and includes more of the segregant than the first portion 216 and the second portion 220. As such, grain boundaries 226 in the third portion 224 are thicker than the grain boundaries 218 in the first portion 216 and the grain boundaries 222 in the second portion 220. In various embodiments, the grain boundaries 226 in the third portion 224 include a greater volume of material than the grain boundaries 218 in the first portion 216 and the grain boundaries 222 in the second portion 220. The grain boundaries 226 define heat conductive grains 227 in the third portion 224. In various embodiments, the third portion 224 maintains the (200) orientation (or (1120) orientation if hcp Ru is used). In some embodiments, the segregant in the third portion 224 may be the same material or a different material than the segregant in the first portion 216 and/or the segregant in the second portion 220. Heat may be applied before or after deposition of the third portion 224 in order to promote and ensure ample diffusion of the segregant into the grain boundaries 226.

As such, a gradient of segregant is utilized to achieve granularity in the heatsink. The amount of the segregant (e.g. mole percentage) increases in overlying layers. For example, the amount of segregant increases from the first portion 216 to the second portion 220. The amount of segregant increases again from the second portion 220 to the third portion 224. Therefore, in various embodiments the mole percentage could increase from 5% to 10% to 15%, or from 10% to 15% to 20%, or from 1% to 3% to 7%. It is understood that these percentages are merely exemplary, and any increasing percentage could be used in the first portion 216, second portion 220, and third portion 224.

In different embodiments, the heat conductive material in the first portion 216, the second portion 220, and the third portion 224 may be the same or different. In addition in different embodiments, the segregant material in the first portion 216, the second portion 220, and the third portion 224 may be the same or different. Furthermore, different embodiments may include more layers with varying amounts of heat conductive material and segregant material in the heatsink layer 214.

A thermal resistor layer 228 overlies the heatsink layer 214, and may be deposited, for example, by sputtering or other techniques. The thermal resistor layer 228 may have a thickness from 5-100 Å. In various embodiments, the thermal resistor layer 228 is granular and maintains the (200) orientation. The thermal resistor layer 228 resists heat and may be used to control the transfer of heat (e.g. lateral transfer of heat) through the HAMR media 100. As such, the thermal resistor layer 228 includes heat resistive grains 231 separated by grain boundaries 230. When the thermal resistor layer 228 is deposited over the heatsink layer 214, the grain boundaries 230 of the thermal resistor layer 228 will align over the grain boundaries (e.g. grain boundary 226) of the heatsink layers. As a result, the granularity will be maintained from the heatsink layer 214 to the thermal resistor layer 228. Heat may be applied before or after deposition of the thermal resistor layer 228 in order to promote and ensure ample diffusion of the segregant into the grain boundaries 230.

For example, the heatsink layer 214 may include MoX grains and boron grain boundaries. The thermal resistor layer 228 may include an MgXO alloy (compound) wherein X may be Ti, Ni, Fe, Co, Cr, etc. MgXO basically is a mixture of NaCl-structured compounds. For example, MgO+TiO is denoted as MgTiO, MgO+NiO is denoted as MgNiO, etc. The thermal resistor may include nitrides with NaCl structure for example, TiN. The thermal resistor layer 228 may also contain amorphous carbon in the amount of 0-50%. When MgXO and carbon are deposited together onto the heatsink layer 214 MgXO will grow on top of MoX grains and maintain (200) orientation, and carbon will segregate into grain boundaries on top of the boron. As such, the granularity continues through the thermal resistor layer 228.

In further embodiments (not shown), the thermal resistor layer 228 may include more than one layer (e.g. 2, 3, 4, or more sublayers). The sublayers may be formed in the same fashion as the heatsink layer 214, with segregant increase from sublayer to overlying sublayer. For example, the carbon mole % may increase from 5% to 10% to 15%. It is understood that the percent values are exemplary and are non-limiting. In addition, it is understood that the thickness of grain boundaries 230 as illustrated is merely exemplary and is not limiting. Indeed, the thickness of grain boundaries 230 may be smaller than, the same as, or bigger than the thickness of underlying grain boundaries 226 in the third portion 224 of the heatsink layer 214.

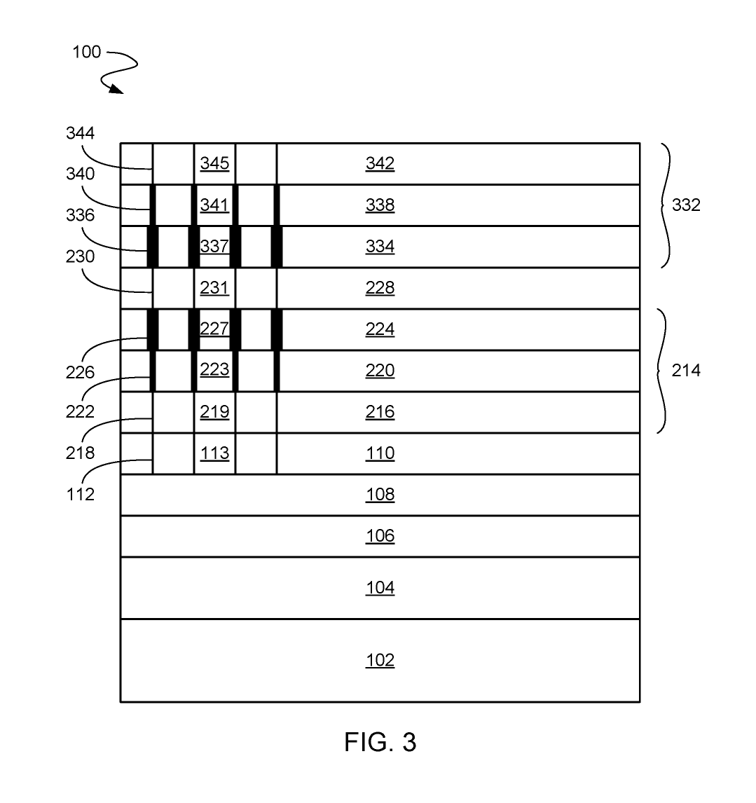

Referring now to FIG. 3, the HAMR media 100 including a recording layer 332 is shown according to one aspect of the present embodiments. The recording layer 332 overlies the thermal resistor layer 228. In the present embodiment, the recording layer 332 includes three layers: a first portion 334, a second portion 338, and a third portion 342. However, it is understood that in various embodiments the recording layer 332 may include any number of layers.

In the present embodiment, the first portion 334 of the recording layer 332 overlies the thermal resistor layer 228. The first portion 334 may have a thickness from 5-100 Å. The first potion 334 includes a magnetic material that is alloyed with a segregant. Grain boundaries 336 include the segregant and define magnetic grains 337 in the first portion 334. As a result, the recording layer 332 is granular. For example, FePtX (a magnetic material) may be alloyed with other elements, such as, carbon (a segregant). The X represents elements such as Cu, Ag, Co, Au, Ir, Re, Rh, Pd, Ni, or combinations of the foregoing. In various embodiments, the first portion 334 changes the crystal orientation to (002) from the (200) orientation of the underlying thermal resistor layer 228. Heat may be applied before or after deposition of the first portion 334 in order to promote and ensure ample diffusion of the segregant into the grain boundaries 336. Heat also ensures chemical order of the FePtX alloys.

A second portion 338 of the recording layer 332 overlies the first portion 334. The second portion 338 may have a thickness from 5-100 Å. The second portion 338 is granular and includes less of the segregant than the first portion 334. As such, grain boundaries 340 in the second portion 338 are thinner than the grain boundaries 336 in the first portion 334. In various embodiments, the grain boundaries 340 in the second portion 338 include a lesser volume of material than the grain boundaries 336 in the first portion 334. The grain boundaries 340 define magnetic grains 341 in the second portion 338. In various embodiments, the second portion 338 maintains the (002) orientation. Heat may be applied before or after deposition of the second portion 338 in order to promote and ensure ample diffusion of the segregant into the grain boundaries 340.

A third portion 342 of the recording layer 332 overlies the second portion 338. The third portion 342 may have a thickness from 5-100 Å. The third portion 342 is granular and includes less of the segregant than the first portion 334 and the second portion 338. As such, grain boundaries 344 in the third portion 342 are thinner than the grain boundaries 336 in the first portion 334 and the grain boundaries 340 in the second portion 338. In various embodiments, the grain boundaries 344 in the third portion 342 include a lesser volume of material than the grain boundaries 336 in the first portion 334 and the grain boundaries 340 in the second portion 338. The grain boundaries 344 define magnetic grains 345 in the second portion 342. In various embodiments, the third portion 342 maintains the (002) orientation. Heat may be applied before or after deposition of the third portion 342 in order to promote and ensure ample diffusion of the segregant into the grain boundaries 344.

As such, a gradient of segregant is utilized to achieve smoothness (e.g. a smooth surface) of the recording layer 332. A smooth surface allows the drive head to fly closer, wherein a rough surface would cause the drive head to crash at an equivalent fly height. In order to achieve a smooth surface, the amount of the segregant (e.g. mole percentage) decreases in overlying layers. For example, the amount of segregant decreases from the first portion 334 to the second portion 338. The amount of segregant decreases again from the second portion 338 to the third portion 342. Therefore, in various embodiments the mole percentage could decrease from 15% to 10% to 5%, or from 20% to 15% to 10%, or from 7% to 3% to 1%. It is understood that these percentages are merely exemplary, and any decreasing percentage could be used in the first portion 334, second portion 338, and third portion 342.

In different embodiments, the magnetic material in the first portion 334, the second portion 338, and the third portion 342 may be the same or different. In addition in different embodiments, the segregant material in the first portion 334, the second portion 338, and the third portion 342 may be the same or different. Furthermore, different embodiments may include more or fewer layers with varying amounts of magnetic material and segregant material in the recording layer 332. In addition, in further embodiments the smoothness of the recording layer 332 may be controlled by other methods. In such embodiments, the first portion 334, the second portion 338, and the third portion 342 may include the same amount of segregant or increasing amounts of segregant.

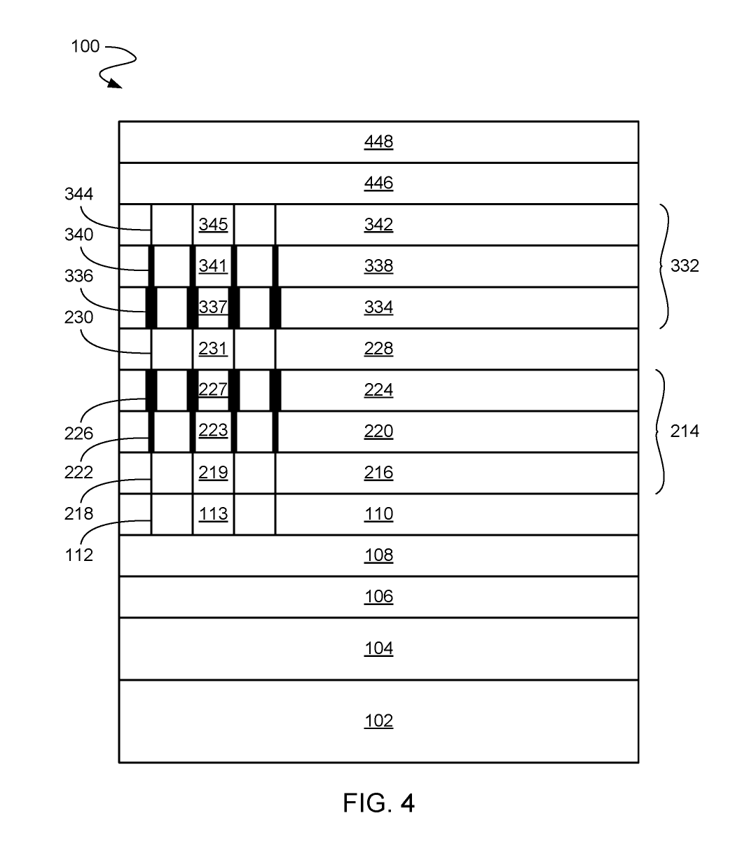

Referring now to FIG. 4, the HAMR media 100 including a magnetic sealer layer 446 and an overcoat layer 448 is shown according to one aspect of the present embodiments. The magnetic sealer layer 446 overlies the recording layer 332, and may be deposited, for example, by sputtering or other techniques. The magnetic sealer layer 446 may have a thickness from 5-50 Å. The magnetic sealer layer 446 further reduces surface roughness, ensuring that a small head to media spacing (“hms”) is maintained. The magnetic sealer layer 446 may include, for example, Pt, PtC, FePtC, etc. In various embodiments, the amount of carbon may vary from 0-20%. The overcoat layer 448 may include materials such as, for example, diamond-like carbon. It is understood that one or more layers may be omitted from the HAMR media 100, or one or more layers may be added to the HAMR media 100, without departing from the scope of the embodiments described herein.

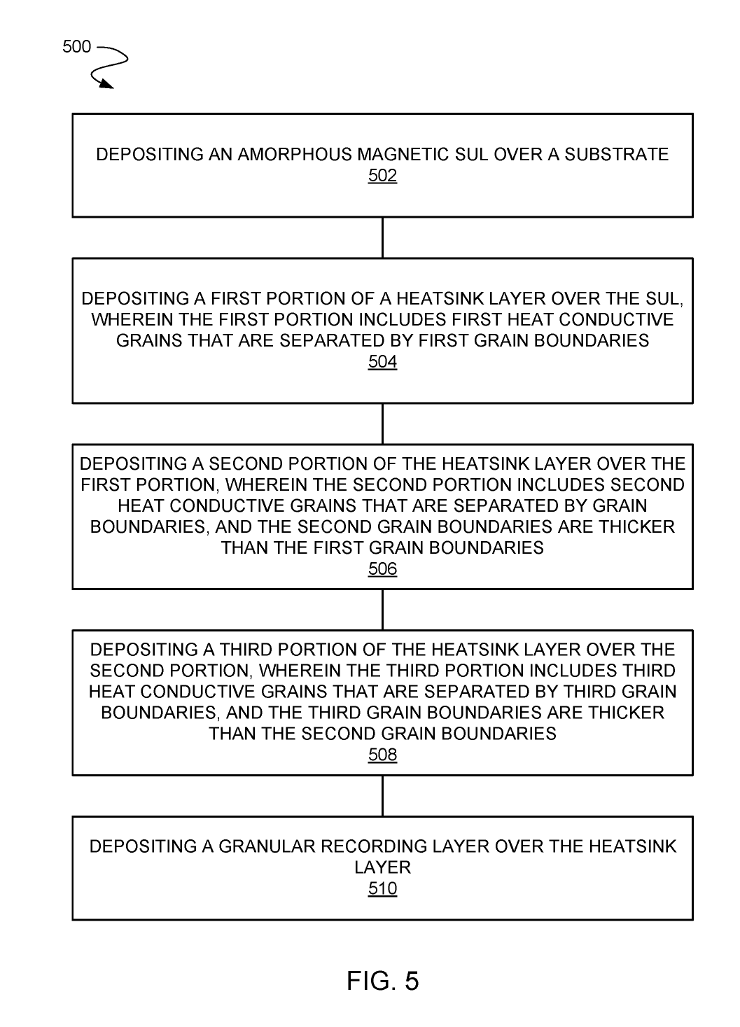

Referring now to FIG. 5, an exemplary flow diagram 500 for creating HAMR media is shown according to one aspect of the present embodiments. At a block 502, an amorphous magnetic soft underlayer (SUL) is deposited over a substrate. For example, in FIG. 1 the SUL overlies the substrate and may be deposited, for example, by sputtering or other techniques.

At a block 504, a first portion of a heatsink layer is deposited over the SUL, wherein the first portion includes first heat conductive grains that are separated by first grain boundaries. For example, in FIG. 2 the first portion of the heatsink is deposited over the SUL, for example, by sputtering or other techniques. The first potion includes a heat conductive material that is alloyed with a segregant. Grain boundaries include the segregant and define heat conductive grains.

At a block 506, a second portion of the heatsink layer is deposited over the first portion, wherein the second portion includes second heat conductive grains that are separated by second grain boundaries, and the second grain boundaries are thicker than the first grain boundaries. For example, in FIG. 2 the second portion of the heatsink is deposited over the first portion of the heatsink, for example, by sputtering or other techniques. The second potion includes a heat conductive material that is alloyed with a segregant. Grain boundaries include the segregant and define heat conductive grains. The second portion includes more of the segregant than the first portion. As such, grain boundaries in the second portion are thicker than the grain boundaries in the first portion.

At a block 508, a third portion of the heatsink layer is deposited over the second portion, wherein the third portion includes third heat conductive grains that are separated by third grain boundaries, and the third grain boundaries are thicker than the second grain boundaries. For example, in FIG. 2 the third portion of the heatsink is deposited over the second portion of the heatsink, for example, by sputtering or other techniques. The third potion includes a heat conductive material that is alloyed with a segregant. Grain boundaries include the segregant and define heat conductive grains. The third portion includes more of the segregant than the second portion. As such, grain boundaries in the third portion are thicker than the grain boundaries in the second portion.

At a block 510, a granular recording layer is deposited over the heatsink layer. For example, in FIG. 3 a recording layer overlies the heatsink layer and may be deposited, for example, by sputtering or other techniques. The heatsink layer includes segregant that defines magnetic grains, and is therefore granular.

In some embodiments, the granular recording layer includes forming a first magnetic layer portion including first magnetic grains separated by first recording layer grain boundaries. A second magnetic layer portion is formed over the first magnetic layer portion, wherein the second magnetic layer portion includes second magnetic grains separated by second recording layer grain boundaries. A third magnetic layer portion is formed over the second magnetic layer portion, wherein the third magnetic layer portion includes third magnetic grains separated by third recording layer grain boundaries. For example, in FIG. 3 the magnetic layer includes a first magnetic layer portion, a second magnetic layer portion, and a third magnetic layer portion deposited over each other, for example, by sputtering or other techniques. Each magnetic layer portion includes magnetic grains that are separated by grain boundaries.

In some embodiments the heatsink layer has a different crystal orientation than the granular recording layer. For example, in FIG. 1 the orientation control layer sets a first crystal orientation of (200). In FIG. 2 the heatsink layer, including the first heat conductive grains, the second heat conductive grains, and the third heat conductive grains, also have the (200) crystal orientation. However, in FIG. 3 the granular recording layer changes to a second crystal orientation of (002) that is different from the first crystal orientation.

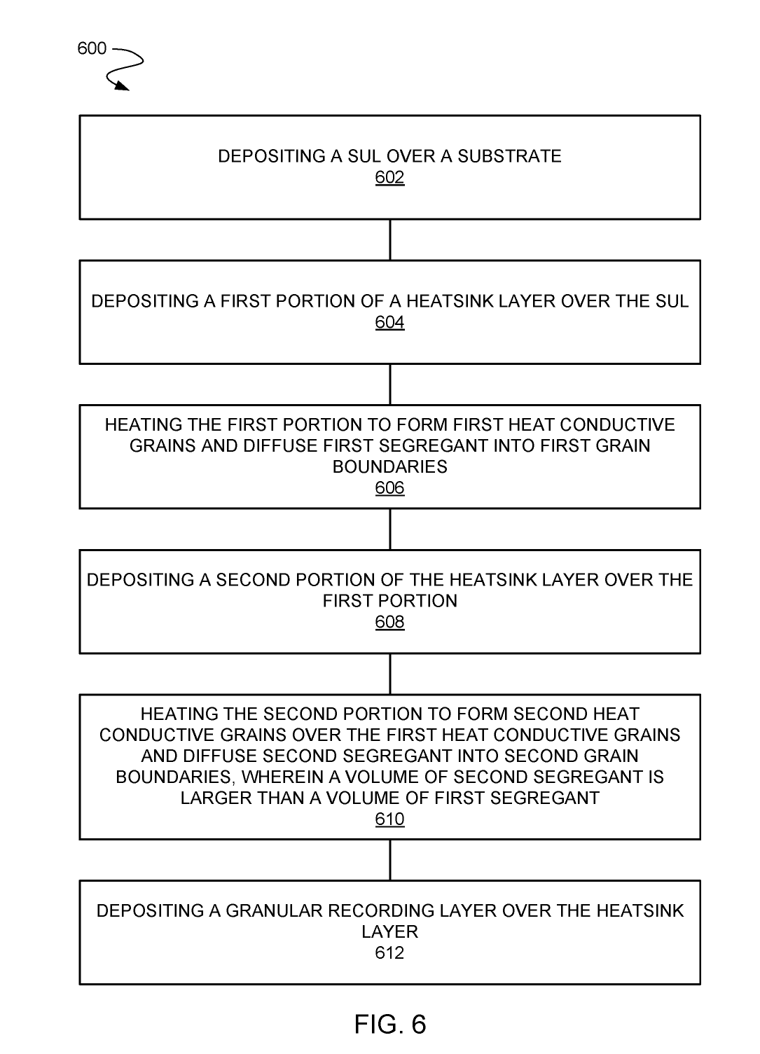

Referring now to FIG. 6, another exemplary flow diagram 600 for creating HAMR media is shown according to one aspect of the present embodiments. At a block 602, a magnetic soft underlayer (SUL) is deposited over a substrate. For example, in FIG. 1 the SUL overlies the substrate and may be deposited, for example, by sputtering or other techniques.

At a block 604, a first portion of a heatsink layer is deposited over the SUL. For example, in FIG. 2 the first portion of the heatsink is deposited over the SUL, for example, by sputtering or other techniques.

At a block 606, the first portion is heated to form first heat conductive grains and diffuse first segregant into first grain boundaries. For example, in FIG. 2 the first potion includes a heat conductive material that is alloyed with a segregant. Heat may be applied before or after deposition of the first portion in order to promote and ensure diffusion of the segregant into the grain boundaries.

At a block 608, a second portion of the heatsink layer is deposited over the first portion. For example, in FIG. 2 the second portion of the heatsink is deposited over the first portion of the heatsink, for example, by sputtering or other techniques.

At a block 610, the second portion is heated to form second heat conductive grains over the first heat conductive grains and diffuse second segregant into second grain boundaries, wherein a volume of second segregant is larger than a volume of first segregant. For example, in FIG. 2 the second potion includes a heat conductive material that is alloyed with a segregant. The second portion includes more of the segregant than the first portion. As such, the grain boundaries in the second portion include a greater volume of material than the grain boundaries in the first portion. Heat may be applied before or after deposition of the second portion in order to promote and ensure diffusion of the segregant into the grain boundaries.

In some embodiments the first segregant is different than the second segregant. For example, in FIG. 2 Mo (a heat conductive material) may be alloyed with other elements (segregants), such as, W, B, Ru, Cr, C, V, Nb, Hf, Zr, and Ti. In addition, other alloys such as W-alloys and Ru-alloys may be used, and may include, for example, B, Ru, W, Mo, Cr, C, V, Nb, Hf, Zr, and Ti as additives. The segregant in the second portion of the heatsink layer may be the same material or a different material than the segregant in the first portion of the heatsink layer.

In some embodiments, a third portion of the heatsink layer is deposited over the second portion. The third portion is heated to form third heat conductive grains over the second heat conductive grains and diffuse third segregant into third grain boundaries, wherein a volume of third segregant is larger than a volume of second segregant. For example, in FIG. 2 the third portion of the heatsink is deposited over the second portion of the heatsink, for example, by sputtering or other techniques. The third potion includes a heat conductive material that is alloyed with a segregant. The third portion includes more of the segregant than the second portion. As such, the grain boundaries in the third portion include a greater volume of material than the grain boundaries in the second portion. Heat may be applied before or after deposition of the second portion in order to promote and ensure diffusion of the segregant into the grain boundaries.

At a block 612, a granular recording layer is deposited over the heatsink layer. For example, in FIG. 3 a recording layer overlies the heatsink layer and may be deposited, for example, by sputtering or other techniques. The heatsink layer includes segregant that defines magnetic grains, and is therefore granular.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A method comprising:
depositing an amorphous magnetic soft underlayer (SUL) over a substrate;
depositing a first portion of a heatsink layer over the SUL, wherein the first portion includes first heat conductive grains that are separated by first grain boundaries;
depositing a second portion of the heatsink layer over the first portion, wherein
the second portion includes second heat conductive grains that are separated by second grain boundaries, and
the second grain boundaries are thicker than the first grain boundaries;
depositing a third portion of the heatsink layer over the second portion, wherein
the third portion includes third heat conductive grains that are separated by third grain boundaries, and
the third grain boundaries are thicker than the second grain boundaries; and
depositing a granular recording layer over the heatsink layer.

2. The method of claim 1, wherein depositing the granular recording layer includes,
forming a first magnetic layer portion including first magnetic grains separated by first recording layer grain boundaries,
forming a second magnetic layer portion over the first magnetic layer portion, wherein the second magnetic layer portion includes second magnetic grains separated by second recording layer grain boundaries, and
forming a third magnetic layer portion over the second magnetic layer portion, wherein the third magnetic layer portion includes third magnetic grains separated by third recording layer grain boundaries.

3. The method of claim 1, wherein the heatsink layer has a different crystal orientation than the granular recording layer.

4. The method of claim 3, wherein the heatsink layer includes a (200) crystal orientation of bcc metals or (1120) of hcp metals and the granular recording layer includes a (002) crystal orientation.

5. The method of claim 1, further comprising depositing an orientation control layer over the SUL wherein the orientation control layer sets a crystal orientation of (200) of bcc metals or (1120) of hcp metals.

6. The method of claim 1, further comprising depositing a granular thermal resistor layer over the heatsink layer.

7. The method of claim 1, further comprising depositing a magnetic sealer layer over the granular recording layer.

8. A method comprising:
depositing a magnetic soft underlayer (SUL) over a substrate;
depositing a first portion of a heatsink layer over the SUL;
heating the first portion to form first heat conductive grains and diffuse first segregant into first grain boundaries;
depositing a second portion of the heatsink layer over the first portion;
heating the second portion to form second heat conductive grains over the first heat conductive grains and diffuse second segregant into second grain boundaries, wherein a volume of second segregant is larger than a volume of first segregant; and
depositing a granular recording layer over the heatsink layer.

9. The method of claim 8, wherein depositing the granular recording layer includes,
forming a first magnetic layer portion including first magnetic grains separated by first recording layer grain boundaries,
forming a second magnetic layer portion over the first magnetic layer portion, wherein the second magnetic layer portion includes second magnetic grains separated by second recording layer grain boundaries, and
forming a third magnetic layer portion over the second magnetic layer portion, wherein the third magnetic layer portion includes third magnetic grains separated by third recording layer grain boundaries.

10. The method of claim 8, wherein the first segregant is different than the second segregant.

11. The method of claim 8, further comprising
depositing a third portion of the heatsink layer over the second portion, and
heating the third portion to form third heat conductive grains over the second heat conductive grains and diffuse third segregant into third grain boundaries, wherein a volume of third segregant is larger than a volume of second segregant.

12. The method of claim 8, wherein the heatsink layer has a different crystal orientation than the granular recording layer.

13. The method of claim 12, wherein the heatsink layer includes a (200) crystal orientation of bcc metals or (1120) of hcp metals and the granular recording layer includes a (002) crystal orientation.

14. The method of claim 8, further comprising depositing an orientation control layer over the SUL.

15. An apparatus comprising:
an orientation control layer over an amorphous magnetic soft underlayer (SUL), wherein the orientation control layer sets a first crystal orientation;
a first portion of a heatsink layer over the orientation control layer, wherein the first portion includes first heat conductive grains that are separated by first grain boundaries;
a second portion of the heatsink layer over the first portion, wherein
the second portion includes second heat conductive grains that are separated by second grain boundaries, and
the second grain boundaries are thicker than the first grain boundaries;
a third portion of the heatsink layer over the second portion, wherein
the third portion includes third heat conductive grains that are separated by third grain boundaries, and
the third grain boundaries are thicker than the second grain boundaries; and
a granular recording layer over the heatsink layer.

16. The apparatus of claim 15, wherein the first heat conductive grains, the second heat conductive grains, and the third heat conductive grains include the first crystal orientation.

17. The apparatus of claim 15, wherein the granular recording layer includes a second crystal orientation that is different from the first crystal orientation.

18. The apparatus of claim 15, wherein the granular recording layer includes
a first magnetic layer portion including first magnetic grains separated by a first recording layer segregant,
a second magnetic layer portion over the first magnetic layer portion, wherein the second magnetic layer portion includes second magnetic grains separated by a second recording layer segregant, and
a third magnetic layer portion over the second magnetic layer portion, wherein the third magnetic layer portion includes third magnetic grains separated by a third recording layer segregant.

19. The apparatus of claim 18, wherein
the second recording layer segregant is thinner than the first recording layer segregant, and
the third recording layer segregant is thinner than the second recording layer segregant.

20. The apparatus of claim 15, further comprising a PtC magnetic sealer layer over the granular recording layer.
